(19) United States
(12) Patent Application Publication
(10) Pub. No.: US 2025/0224354 A1
(43) Pub. Date: Jul. 10, 2025

(54) METHOD FOR MONITORING THE THERMAL PERFORMANCE OF A TEMPERATURE-CONTROLLED TRANSPORT CONTAINER

(71) Applicant: REP IP AG, Zug (CH)

(72) Inventors: Nico ROS, Riehen (CH); Stefan RETZKO, Zürich (CH)

(73) Assignee: REP IP AG, Zug (CH)

(21) Appl. No.: 18/850,489

(22) PCT Filed: Mar. 16, 2023
(86) PCT No.: PCT/IB2023/052559

§ 371 Date: Sep. 24, 2024

(30) Foreign Application Priority Data
Mar. 28, 2022 (AT) A 79/2022

(51) Int. Cl. G01N 25/18

(52) U.S. Cl. CPC G01N 25/18

(57) ABSTRACT

Method for monitoring thermal performance of temperature-controlled transport container. External temperature sensor is provided for measuring ambient temperature of container and internal temperature sensor is provided for measuring internal temperature. Ambient and internal temperature are measured and recorded while passing through first interior temperature range during first time period, and ambient and interior temperature are measured and recorded while passing through second interior temperature range during second time period. The phase change temperature is in first temperature range, and second temperature range is above or below the first temperature range. Thermal conductivity of the insulation layer is calculated based on temporal change of interior temperature relative to ambient temperature while passing through second temperature range, and subsequently enthalpy of phase change material is calculated based on temporal change of interior temperature relative to ambient temperature while passing through first temperature range and based on thermal conductivity of insulation layer.

### CROSS-REFERENCE TO RELATED APPLICATIONS

The present application is a national phase application of PCT Application No. PCT/IB2023/052559, filed Mar. 16, 2023, entitled “METHOD FOR MONITORING THE THERMAL PERFORMANCE OF A TEMPERATURE-CONTROLLED TRANSPORT CONTAINER”, which claims the benefit of Austrian Patent Application No. A 79/2022, filed Mar. 28, 2022, each of which is incorporated by reference in its entirety.

### BACKGROUND OF THE INVENTION

### 1. Field of the Invention

The invention relates to a method for monitoring the thermal performance of a temperature-controlled transport container. The invention further relates to a system for monitoring the thermal performance of a temperature-controlled transport container, comprising a transport container and a computing unit.

### 2. Description of the Related Art

When transporting temperature-sensitive transport goods, such as pharmaceuticals, over periods of several days, predetermined temperature ranges must be maintained during storage and transport in order to ensure the usability and safety of the transport goods. For various pharmaceuticals, temperature ranges from 2 to 25° C., in particular 2 to 8° C. or 15 to 25° C., are established as storage and transport conditions.

In order to permanently and demonstrably maintain the desired temperature range of the transport goods during transport, transport containers, e.g. air cargo containers, with special insulation capacity are used. Containers are known from the state of the art whose container walls comprise a thermal insulation layer and which are equipped with passive temperature control elements. Layered wall structures made of standard insulating material such as EPS, PIR or XPS as well as high-performance insulation such as vacuum panels (VIP) are used for the insulation. Passive temperature control elements do not require any external energy supply during use, but use their heat storage capacity, whereby, depending on the temperature level, there is a release or absorption of heat to or from the interior of the transport container to be tempered. Such passive temperature control elements are exhausted as soon as the temperature equalisation with the interior of the transport container is completed.

A particular form of passive temperature control elements are latent heat storages that can store thermal energy in phase change materials whose latent heat of fusion, heat of solution, or heat of absorption is substantially greater than the heat they can store due to their normal specific heat capacity.

For the planning of temperature-controlled freight transports, knowledge of the thermal performance of the transport containers is essential. Typically, the thermal performance of temperature-controlled transport containers with passive cooling systems is determined in dedicated validation measurements. In a certified climatic chamber, a temperature profile is scanned in the desired range and the change in temperature in the interior of the transport container is measured with several sensing elements. This gives very accurate data on the performance of the container in question.

However, the disadvantage is that these validation measurements are relatively time-consuming and costly and thus cannot be carried out for each individual transport container. The typically occurring variations in the thermal conductivity of the insulation and the enthalpy of the latent heat storage are not taken into account. Furthermore, the validation measurements are carried out only once and thus represent only snapshots for individual containers. Changes in the thermal conductivity of the insulation over time (e.g. due to an increase in the vacuum pressure of vacuum panels as a result of damage) or the enthalpy of the latent heat storage are not detected.

As a result, performance predictions have to use large safety factors or, in the worst case, the guaranteed temperature range cannot be maintained.

The publication WO 2022/054024 A1 shows and describes a method for calculating the insulation performance of a container wall. A method for calculating the enthalpy of a phase change material is disclosed, for example, in TAN PEPE ET AL: “Correction of the enthalpy-temperature curve of phase change materials obtained from the T-History method based on a transient heat conduction model”, INTERNATIONAL JOURNAL OF HEAT AND MASS TRANSFER, ELSEVIER, AMSTERDAM, NL, Vol. 105, Oct. 14, 2016 (2016Oct. 14), pages 573-588.

### SUMMARY OF THE INVENTION

The present invention is intended to enable continuous monitoring of the thermal performance of all transport containers of the fleet in use. It should be possible to determine both the thermal conductivity of the insulation and the enthalpy of the latent heat storage with simple means. Monitoring should be possible in the context of standard operation without additional instrumentation having to be used.

To achieve this object, the invention provides, according to a first aspect, a method for monitoring the thermal performance of a temperature-controlled transport container, wherein the transport container includes a container wall and an interior surrounded by the container wall, wherein the container wall comprises a thermal insulation layer surrounding the interior on all sides and a latent heat storage layer, wherein the latent heat storage layer includes a phase change material having a phase change temperature, and wherein an external temperature sensor for measuring the ambient temperature of the transport container and an internal temperature sensor for the measuring the interior temperature are provided, wherein the ambient temperature and the interior temperature are measured and recorded during a first time period in which the interior temperature is passing through a first interior temperature range, and the ambient temperature and the interior temperature are measured and recorded during a second time period in which the interior temperature is passing through a second interior temperature range, wherein the phase change temperature is within the first temperature range, and the second temperature range is above or below the first temperature range, wherein the thermal conductivity of the insulation layer is calculated based on the temporal change of the interior temperature relative to the ambient temperature while passing through the second temperature range, and wherein subsequently the enthalpy of the phase change material is calculated based on the temporal change of the interior temperature relative to the ambient temperature while passing through the first temperature range and based on the thermal conductivity of the insulation layer.

The physical relationships on which the invention is based are explained in more detail below with reference to an exemplary embodiment.

According to the energy conservation law, heat transfer (Qᵢ) leads to a change in the internal energy (ΔU) of the transport container:

$$Δ U = {Q}_{i} \qquad ( 1 )$$

The change in the internal ene [symbol] good approximation by equation (2).

$$Δ U = {m}_{P C M} \cdot \int {c}_{P C M} ( T ) \cdot dT + {C}_{s} \cdot Δ T \qquad ( 2 )$$

Here, C_{PCM}(T) is the temperature-dependent specific heat capacity of the phase change material. C_{S} is the temperature-independent heat capacity of the other components of the transport container (insulation, structural parts), which is determined with the help of a validation measurement and is transferable to other containers.

The heat input into the container can be calculated in a simplified manner with equation (3).

$${Q}_{i} = f \cdot {A}_{r e f} \cdot \frac{{λ}_{i s o}}{{d}_{i s o}} \cdot \int [ {T}_{a m b} ( t ) - {T}_{i} ( t ) ] \cdot df \qquad ( 3 )$$

Here, f represents a correction factor that is determined via validation measurements and is transferable to other transport containers.

### BRIEF DESCRIPTION OF THE DRAWINGS

The Figures show the following:

FIG. 1 shows a graph illustrating the relationship between specific heat capacity of a phase change material with respect to temperature; and

FIG. 2 illustrates a transport container suitable for carrying out the invention.

### DETAILED DESCRIPTION

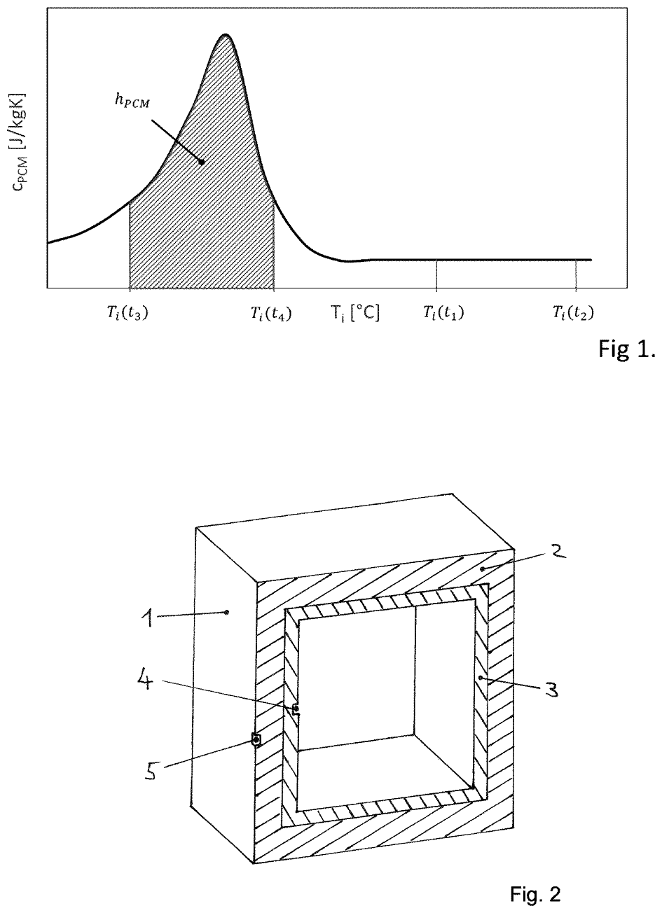

The phase change of the latent heat storage is usually within the operating interval of the corresponding container. This results in a maximum in the distribution of the specific heat capacity of the phase change material in this temperature range. Outside this range, the specific heat capacity of the phase change material is almost constant and very well known (see FIG. 1). Therefore, this range is well suitable for calculating the thermal conductivity of insulation with equation (4).

$${λ}_{iso} = \frac{( {m}_{P C M} \cdot {c}_{PCM} + {C}_{s} ) \cdot [ {T}_{i} ( {t}_{2} ) - {T}_{i} ( {t}_{1} ) ] \cdot {d}_{iso}}{f \cdot {A}_{r e f} \cdot {\int }_{{t}_{1}}^{{t}_{2}} [ {T}_{amb} ( t ) - {T}_{i} ( t ) ] \cdot dt} \qquad ( 4 )$$

Since C_{PCM}(T) is constant in the considered temperature range, the integral in equation (2) is simplified to C_{PCM}ΔT. An example: The typical operating temperature range of a transport container for the pharmaceutical industry is 2-8° C. A suitable phase change material should have a maximum of the specific heat capacity at about 5° C. A suitable temperature range for measuring the thermal conductivity according to equation (4) would therefore be, for example, 10-15° C. The measurement is automatically started at a temperature of 10° C. at time t₁. As soon as the temperature inside the container has a value of 15° C., the measurement is stopped at time t₂ and evaluated with equation (4).

With the help of the now known thermal conductivity of the insulation, the enthalpy of the latent heat storage can be calculated with equation (5). For this purpose, the desired temperature range must be passed through within the operating temperature interval of the container, so that a phase change occurs.

$${h}_{PCM} {\vert}_{{T}_{i} ( {t}_{3} ) \to {T}_{i} ( {t}_{4} )} = \frac{1}{{m}_{P C M}} \cdot [ f \cdot {A}_{ref} \cdot \frac{{λ}_{iso}}{{d}_{iso}} \cdot {\int }_{{t}_{3}}^{{t}_{4}} [ {T}_{amb} ( t ) - {T}_{i} ( t ) ] \cdot dt - {C}_{s} \cdot [ {T}_{i} ( {t}_{4} ) - {T}_{i} ( {t}_{3} ) ] ] \qquad ( 5 )$$

In the example above, a temperature interval of 2-8° C. would be conceivable. The measurement is started at a temperature of 2° C. at time t₃ and runs until a temperature of 8° C. has been reached (time t₄).

| Symbol | Unit | Description |
|---|---|---|
| A_{ref} | [m²] | Reference surface area A_{ref} = A_{inside} + 0.3 |
| | | (A_{outside} − A_{inside}) |
| C_{PCM} | [J/kgK] | Specific heat capacity of the phase change material |
| Cₛ | [J/K] | Heat capacity of the structural parts and |
| | | insulation of the transport container |
| dᵢₛₒ | [m] | Wall thickness of the insulation layer |
| f | [—] | Correction factor for heat input - From |
| | | validation measurements |
| h_{PCM} | [J/kg] | Specific enthalpy of the phase change material |
| λᵢₛₒ | [W/mK] | Thermal conductivity of the insulation layer |
| m_{PCM} | [kg | Mass of the phase change material |
| Qᵢ | [W] | Energy input |
| T_{amb} | [K] | Ambient temperature |
| Tᵢ | [K] | Temperature inside the transport container |
| t | [s] | Time |
| t₁ | [s] | Starting time for measuring the thermal conductivity |
| | | of the insulation |
| t₂ | [s] | End time for measuring the thermal conductivity |
| | | of the insulation |
| t₃ | [s] | Starting time for measuring the enthalpy of the |
| | | phase change material |
| t₄ | [s] | End time for measuring the enthalpy of the phase |
| | | change material |
| ΔU | [W] | Change in the internal energy of the transport container |

A transport container suitable for carrying out the invention is explained in more detail with reference to FIG. 2, which shows a sectional view of the transport container. The transport container comprises a cuboid wall 1, which encloses the interior of the transport container. A door is provided on a front side (not shown) of the transport container, via which the interior can be loaded and unloaded. The wall 1 comprises a thermal insulation layer 2 made of a material with a thermal conductivity of <0.02 W/(m·K), preferably <0.012 W/(m·K), such as vacuum insulated panels. A latent heat storage layer 3, which comprises a phase change material, is arranged on the side of the insulation layer 2 facing the interior. For measuring the interior temperature, an internal temperature sensor 4 is arranged on the side of the latent heat storage layer 3 facing the interior. For measuring the ambient temperature, an external temperature sensor 5 is arranged on the outside of the transport container. The measurement signals of the internal temperature sensor 4 and of the external temperature sensor 5 are supplied to a measured value memory (not shown) or to a computing unit, in which the thermal conductivity of the insulation layer and the enthalpy of the phase-change material are determined according to the invention.

1-7. (canceled)

8. A method for monitoring the thermal performance of a temperature-controlled transport container, the transport container including a container wall and an interior surrounded by the container wall, the container wall comprising a thermal insulation layer surrounding the interior on all sides and a latent heat storage layer, the latent heat storage layer including a phase change material having a phase change temperature, comprising:
providing an external temperature sensor for measuring an ambient temperature of the transport container and an internal temperature sensor for measuring an interior temperature;
measuring and recording a first ambient temperature and a first interior temperature during a first period of time in which the first interior temperature passes through a first temperature range, the phase change temperature being within the first temperature range;
measuring and recording a second ambient temperature and a second interior temperature during a second period of time in which the second interior temperature passes through a second temperature range, the second temperature range being above or below the first temperature range;
calculating a thermal conductivity of the insulation layer based on a first temporal change of the interior temperature relative to the ambient temperature while passing through the second temperature range; and
calculating subsequently an enthalpy of the phase change material based on a second temporal change of the interior temperature relative to the ambient temperature while passing through the first temperature range and based on the thermal conductivity of the insulation layer.

9. The method according to claim 8, wherein a range in which a specific heat capacity of the phase change material is substantially constant is selected as the second temperature range.

10. The method according to claim 8, wherein the first temperature range extends from a temperature of 1-4° C. below the phase change temperature to a temperature of 1-4° C. above the phase change temperature.

11. The method according to claim 8, wherein the second temperature range is passed through with increasing interior temperature.

12. The method according to claim 8, wherein the calculation of the thermal conductivity of the insulation layer is carried out with the formula,
$${λ}_{iso} = \frac{( {m}_{P C M} \cdot {c}_{PCM} + {C}_{s} ) \cdot [ {T}_{i} ( {t}_{2} ) - {T}_{i} ( {t}_{1} ) ] \cdot {d}_{iso}}{f \cdot {A}_{r e f} \cdot {\int }_{{t}_{1}}^{{t}_{2}} [ {T}_{amb} ( t ) - {T}_{i} ( t ) ] \cdot dt}$$
with the following meanings:
m_{PCM}: Mass of phase change material [kg]
C_{PCM}: Specific heat capacity of the phase change material [J/kg·K]
C_{S}: Heat capacity of the structural parts and of the insulation of the transport container [J/K]
Tᵢ(t₂): Internal temperature at the end of the second temperature range [K]
Tᵢ(t₁): Internal temperature at the beginning of the second temperature range [K]
dᵢₛₒ: Wall thickness of the insulation layer [m]
f: Correction factor for heat input
A_{ref}: Reference surface area A_{ref}=A_{inside}+0.3(A_{outside}−A_{inside}) [m²]
T_{amb}: Ambient temperature [K].

13. The method according to claim 12, wherein the calculation of the enthalpy of the phase change material is carried out with the formula
$${h}_{PCM} {\vert}_{{T}_{i} ( {t}_{3} ) \to {T}_{i} ( {t}_{4} )} = \frac{1}{{m}_{P C M}} \cdot [ f \cdot {A}_{ref} \cdot \frac{{λ}_{iso}}{{d}_{iso}} \cdot {\int }_{{t}_{3}}^{{t}_{4}} [ {T}_{amb} ( t ) - {T}_{i} ( t ) ] \cdot dt - {C}_{s} \cdot [ {T}_{i} ( {t}_{4} ) - {T}_{i} ( {t}_{3} ) ] ]$$
with the following meanings:
h_{PCM}: Specific heat capacity of the phase change material
Tᵢ(t₄): Internal temperature at the end of the first temperature range [K]
Tᵢ(t₃): Internal temperature at the beginning of the first temperature range [K].

14. A system for monitoring the thermal performance of a temperature-controlled transport container, comprising
a transport container with a container wall and an interior surrounded by the container wall, wherein the container wall comprises a thermal insulation layer surrounding the interior on all sides and a latent heat storage layer, wherein the latent heat storage layer includes a phase change material having a phase change temperature, and wherein the transport container comprises an external temperature sensor for measuring the ambient temperature of the transport container and an internal temperature sensor for measuring the interior temperature, and wherein the transport container comprises a measured value memory to which the measured values of the external temperature sensor and the internal temperature sensor are supplied, which are measured during a first time period in which the interior temperature passes through a first temperature range, and which are measured during a second time period in which the interior temperature passes through a second temperature range, wherein the phase change temperature is within the first temperature range and the second temperature range is above or below the first temperature range, and
a computing unit for evaluating the measurement data, wherein the transport container and the computing unit each include a data transmission interface, via which the measured values are transmitted from the measured value memory of the transport container to the computing unit, and wherein the computing unit is configured to calculate a thermal conductivity of the insulation layer based on the temporal change of the interior temperature relative to the ambient temperature while passing through the second temperature range and subsequently to calculate an enthalpy of the phase change material based on the temporal change of the interior temperature relative to the ambient temperature while passing through the first temperature range and based on the thermal conductivity of the insulation layer.
